(19) United States
(12) Patent Application Publication
(10) Pub. No.: US 2007/0241882 A1
(43) Pub. Date: Oct. 18, 2007

(54) User Interface for Real-Time Management of Vehicles

(75) Inventors: James T. Panttaja, Healdsburg, CA (US); William Joseph Creekbaum, San Mateo, CA (US); Barbara J. Lyon, San Rafael, CA (US); Margaret Leslie Sorentino, Santa Rosa, CA (US); BD Madhuchandra, Fremont, CA (US); David Alan Kinsfather, San Francisco, CA (US); Mahesh Malani, San Francisco, CA (US); Sandy Denise Barletta, Boulder City, NV (US); Richard Hess, Bremerton, WA (US)

Correspondence Address: FENWICK & WEST LLP, SILICON VALLEY CENTER, 801 CALIFORNIA STREET, MOUNTAIN VIEW, CA, 94041, US

(73) Assignee: SAPIAS, INC., San Francisco, CA (US)

(21) Appl. No.: 11/736,780

(22) Filed: Apr. 18, 2007

Related U.S. Application Data
(60) Provisional application No. 60/792,721, filed on Apr. 18, 2006.

(51) Int. Cl. G08B 19/00; B60Q 1/00; G08B 1/00

(52) U.S. Cl. 340/521; 340/438; 340/531

(57) ABSTRACT

A method, system, and computer readable memory product produces a user interface for real-time management of vehicles. The user interface displays groups of vehicle and corresponding key performance indicators for each. The user interface enables fields corresponding to certain metrics to be visually distinguished in response to the metric exceeding a specified threshold value for a key performance indicator. The user interface may be refined to display various levels of greater or lesser detail, or to display the data in additional or alternative formats.

### RELATED APPLICATIONS

This application claims the benefit of U.S. Provisional Application Ser. No. 60/792,721, filed Apr. 18, 2006, which is incorporated herein in its entirety by reference.

### BACKGROUND

1. Field of the Invention

This invention pertains in general to managing vehicles in real-time and in particular to displaying data for groups of vehicles on a user interface.

2. Description of the Related Art

Various enterprises use vehicles as a means to provide service to their clients scattered around a geographical area. In order to efficiently run their operations these enterprises track individual vehicles and analyze their on-board data so as to evaluate the performance of each vehicle. For example, they may track the engine idle time of each vehicle to determine which vehicle is spending the most time idling and consequently not performing the assigned tasks on time. These enterprises deal with a few tens (typically around 25-30) of vehicles at any time and so the focus has been on limiting the performance evaluations to each vehicle as a separate entity.

Currently, these enterprises have expanded to include hundreds of vehicles and existing systems continue to infer performance by analyzing data from individual vehicles. Supervisors find it increasingly difficult to draw conclusions on performance from vast quantities of data from these individual vehicles. As a consequence, the sheer volume of data prevents supervisors from quickly drawing their attention to those vehicles with poor performance by simply scanning data on individual vehicles. The problem gets compounded when these enterprises scale up their operations and expand their fleet of vehicles e.g. operate in different geographical areas and performances need to be evaluated across these different areas. With the focus on individual vehicles, current vehicle management systems do not lend themselves to scale-up very well as vehicle fleet sizes continue to go up. A visual tool to aid in vehicle management for large fleets of vehicles is also lacking.

Accordingly, there is a need in the art for a way to manage vehicles in real-time that does not suffer from the drawbacks described above.

### BRIEF SUMMARY OF THE INVENTION

The above and other needs are met by a method, system, and computer readable memory product that produces a user interface for real-time management of vehicles. The user interface displays a group listing area that shows various groups, each group corresponding to vehicles, and displays a summary data display area including fields comprising metrics for a plurality of key performance indicators associated with the vehicles in the groups. The user interface enables fields corresponding to certain metrics to be visually distinguished in response to the metric exceeding a specified threshold value for a key performance indicator.

The user interface may be refined to display various levels of greater or lesser detail, for example showing data aggregated across all key performance indicators for a group, or showing subgroup or individual vehicle data. In addition, the user interface may be refined to display the data in additional or alternative formats, such as time trend data and mapping data.

### BRIEF DESCRIPTION OF THE DRAWINGS

FIG. 1 is a high-level entity diagram corresponding to a vehicle management system for real-time management of vehicles according to one embodiment.

FIG. 2 is a high-level block diagram illustrating modules for use with a vehicle management system according to one embodiment.

FIG. 3 is a flowchart illustrating a method of displaying data for real-time management of vehicles according to one embodiment.

FIG. 4 is a flowchart illustrating various display options available in conjunction with the method of FIG. 3 according to one embodiment.

FIG. 5 is a sequence diagram illustrating backend functionality for the vehicle management system according to one embodiment.

FIG. 6A shows a user interface for a method of real-time management of vehicles corresponding to an enterprise according to one embodiment.

FIG. 6B shows a user interface for a method of real-time management of vehicles corresponding to a group (or subgroup) according to one embodiment.

FIG. 6C shows a user interface for a method of real-time management of vehicles corresponding a subgroup according to one embodiment.

FIG. 6D shows a user interface for a method of real-time management of vehicles corresponding to a group metric aggregation according to one embodiment.

FIG. 6E is a user interface for a method of real-time management of vehicles including a time trend graph for a method of real-time management of vehicles including a map display area according to one embodiment.

FIG. 6F shows a user interface for a method of real-time management of vehicles including a map display area according to one embodiment.

The figures depict embodiments for purposes of illustration only. One skilled in the art will readily recognize from the following description that alternative embodiments of the structures and methods illustrated herein may be employed without departing from the principles described herein.

### DETAILED DESCRIPTION OF THE PREFERRED EMBODIMENTS

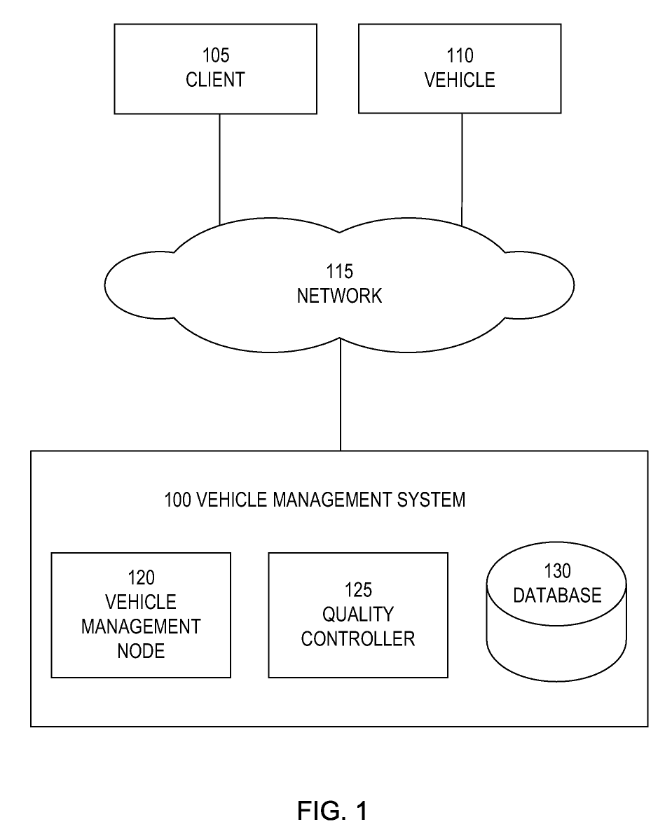

FIG. 1 is a high-level entity diagram corresponding to a vehicle management system 100 for real-time management of vehicles according to one embodiment. The entities include the vehicle management system 100, at least one client 105, and at least one vehicle 110 communicatively coupled via a network 115. More than one client 105 and one vehicle 110 are generally involved, however, FIG. 1 shows only one client 105 and one vehicle 110 for clarity of explanation.

The vehicle management system 100 exchanges messages with the vehicle 110 and provides sophisticated data-driven message processing capabilities. The processing capabilities are utilized to provide monitoring, managing, reporting, and notifying functionality, e.g., to one or more clients 105. For example, in one embodiment the vehicle management system 100 provides functionality for monitoring and managing a fleet of trucks 110 on delivery routes. The vehicle management system 100 processes messages from the trucks 110 to perform functions such as determining whether trucks 110 are on schedule, whether trucks 110 have deviated from assigned routes, whether the trucks 110 are speeding, etc.

The client 105 may be a person, computer system, application, or other entity that communicates with the vehicle management system 100 for the functionality described herein. The vehicle management system 100 and client 105 can communicate via a variety of technologies and interfaces. For example, the client 105 can communicate with the vehicle management system 100 using a telephone-based interactive voice response (IVR) interface, a web page-based interface, an email interface, data exchanged via a network connection utilizing the TCP/IP, and/or a dedicated application interface, such as the user interface described herein. The client 105 can utilize a variety of devices to access these interfaces, including a telephone, computer system, pager, etc. These communications can utilize conventional wired and/or wireless data and/or voice communications links. In one embodiment, the client 105 is a thin client that minimally provides a user interface (not shown) to not only generate requests that are processed remotely on the vehicle management system 100 but also to display the results transmitted back from the vehicle management system 100.

The one or more vehicles 110 exchange messages with the vehicle management system 100 as described above. The vehicles 110 may be any known type of mobile transportation device. The vehicles 110 may be grouped, for example, as part of an enterprise. Such enterprises may include various service companies, gas and electric companies, field service technicians, various mobile functional groups, and cable companies. The vehicle 110 includes components to support the messaging capability.

The vehicle 110 also may include various components for tracking the vehicle, controlling and monitoring vehicle system components and parameters, and/or for communicating with the vehicle management system 100. The components may include a tracking device supporting position determination and position reporting, e.g., adapted for use with the satellite-based Global Positioning System (GPS). In other embodiments, other position determination systems may be used.

The network 115 may be any type of network, including wireless networks. The network 115 may be the Internet, or other network embodiments, such as a LAN, a WAN, a MAN, a wired or wireless network, a private network, a virtual private network, or other systems allowing for data communication between two or more computing systems. The network 115 enables communication between the vehicle management system 100 and the vehicle 110, and with the client(s) 105.

In conjunction with the various network 115 types, the connections between the entities and the network 115 may take various configurations. In one embodiment, the vehicle 110 uses conventional cellular wireless communication technologies to exchange messages with the vehicle management system 100, including cellular telephone technologies using the cell control channel, code division multiple access (CDMA), general packet radio service (GPRS), satellite-based communication technologies, etc. The vehicle 110 can also use conventional wireless computer networking technologies, such as 802.11, to communicate with the vehicle management system 100. In other embodiments, the vehicle 110 utilizes satellite-based communication technologies, non-cellular based radio communication technologies, and/or other technologies. Communication between the vehicle 110 and the vehicle management system 100 is preferably bi-directional and the vehicle 110 and vehicle management system 100 can utilize different technologies for different directions of communication.

The vehicle management system 100 in turn comprises a vehicle management node 120, a quality controller 125, and a database 130. The vehicle management node 120 comprises a set of software modules that handle incoming and outgoing requests/data and further group, summarize, aggregate and visually distinguish the metrics associated with key performance indicators (KPIs) that measure the performance of either individual vehicles or groups of vehicles. For the purposes of the present invention, a group of vehicles is defined as a collection of one or more subgroups of vehicles or simply a collection of individual vehicles. The collection may be nested, as a subgroup may in turn comprise a collection of one or more vehicles or one or more subgroups of vehicles.

The quality controller 125 assures the quality of data uploaded by each vehicle 110 to the database 130 within the vehicle management system 100. For example, the quality controller 125 may query the database 130 for the stored states of individual vehicles for comparison to the current states, e.g., to determine if received data are plausible and/or different from the stored data.

The database 130 may be a set of files on disk, a relational database, or any other form of storage. The database 130 may be accessible by the quality controller 125. The database 130 may be a relational database that not only holds the raw on-board data uploaded by each vehicle 110 but also stores the group data derived from the individual vehicle data by the vehicle management node 120. In one embodiment, the database 130 employs alternate models such as a flat model, a hierarchical model, a network model, an object database model, or any hybrids thereof. In another embodiment, the database 130 uses a dimensional model to represent data in data warehouses so that data may be summarized using online analytical processing (OLAP), data mining, extract transform load (ETL), or other business intelligence approaches.

One skilled in the art will recognize that the system architecture illustrated in FIG. 1 is merely exemplary, and that other embodiments may be practiced and implemented using many other architectures and environments.

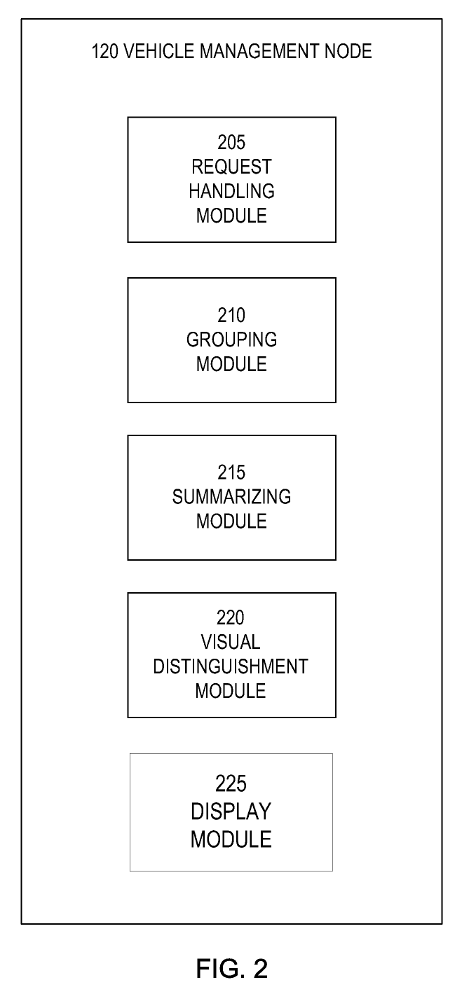

FIG. 2 is a high-level block diagram illustrating modules for use with a vehicle management system 100 according to one embodiment. Other embodiments can have different and/or additional modules than the ones shown in the figure. In addition, the functions can be distributed among the modules in a different manner than is described here.

The request handling module 205 handles requests from the client 105, the vehicle 110, or from other components of the vehicle management system 100. The request handling module 205 receives on-board data from an individual vehicle 110 and forwards them to the quality controller 125 for further processing. The request handling module 205 receives data requests from the client 105 and proceeds to retrieve the data from the database 130 before forwarding the results back to the client 105. The request handling module 205 also receives query results from the database 130 to serve the needs of the other modules within vehicle management node 120, as needed.

The grouping module 210 within the vehicle management node 120 performs the task of grouping individual vehicles into groups or subgroups of one or more vehicles. In one embodiment, the groups are created based on user-defined criteria, e.g. group by region, group by district, group by vehicle type or model, or group by vehicle function. In another embodiment, the grouping module 210 leverages a geographic information system (GIS) optionally managed by the database 130 to dynamically group the vehicles, e.g. group vehicles currently within a 10 mile radius of a specified location. Optionally, the grouping module 210 further divides groups into subgroups, which in turn may be composed of additional subgroups or individuals. For the purposes of the present description, a subgroup is defined as a subset of either a group or a subgroup. For example, a group may consist of either individual vehicles or subgroups of vehicles. Each of these subgroups of vehicles may further comprise subgroups or individuals. If a group or subgroup does not comprise subgroups, then they comprise one or more individual vehicles. The grouping module 210 sends the results of the grouping to the request handling module 205 which then forwards them to the client 105 for display on the user interface.

The summarizing module 215 within the vehicle management node 120 performs the task of generating summary data on the metrics associated with the key performance indicators (KPIs) on groups of vehicles. The summarizing module 215 also generates subgroup data on the metrics associated with the key performance indicators (KPIs) on subgroups of vehicles. The summarizing module 215 further generates individual data on the metrics associated with the key performance indicators (KPIs) on individual vehicles. The summarizing module 215 also performs aggregation of the summary/subgroup/individual data as a single value for each KPI across all the groups/subgroups/individuals respectively in the user interface display. In one embodiment, the summarizing module 215 further performs aggregation of the summary/subgroup/individual data either as a single value for each of the groups/subgroups/individuals respectively in the user interface display across all KPIs selected on the user interface. The summarizing module 215 sends the summary/subgroup/individual data to the request handling module 205 which then forwards them to the client 105 for display on the user interface.

The visual distinguishment module 220 within the vehicle management node 120 performs the task of visually distinguishing summary/subgroup/individual data on the metrics associated with the key performance indicators (KPIs) on groups/subgroups/individuals respectively, whenever the metric fails to meet a user-defined threshold value. One of skill in the art would recognize that different user-defined KPIs may have different threshold values and employ different mathematical operators to establish the threshold values. The visual distinguishment module 220 visually distinguishes metrics for a summary/subgroup/individual on the user interface, and may send such data to the request handling module 205. In one-embodiment, the visual distinguishment may take the form of a color-coding scheme. Other embodiments may employ other means of visual distinguishment.

The display module 225 enables display of the functionality described above on the user interface. The display module 225 enables displaying a listing of groups of vehicles corresponding to an enterprise and summary data for each group, subgroup, individual vehicle, or aggregation. The display module 225 is responsible for updating the user interface in response to user input requesting a change in the level of detail displayed in the user interface and in response to user input requesting a change in the format of the data displayed in the user interface.

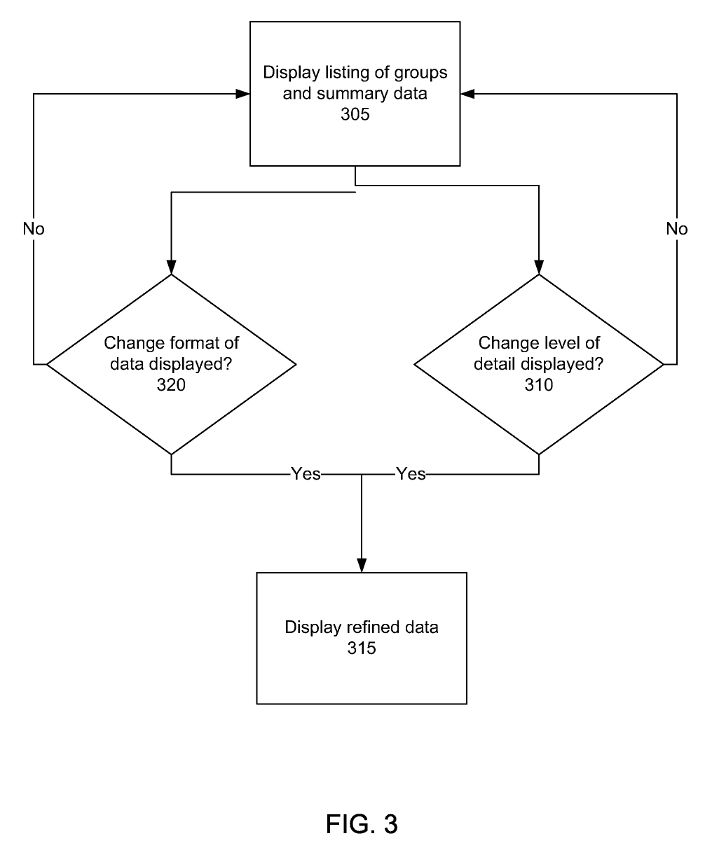

FIG. 3 is a flowchart illustrating a method of displaying data for real-time management of vehicles according to one embodiment. The method begins by displaying 305 a listing of groups of vehicles corresponding to an enterprise and summary data for each group. The summary data may include metrics for each group corresponding to key performance indicators (KPIs). As used herein, KPIs represent scalar attributes used to measure performance for one or more vehicles. KPIs for a group, subgroup, or vehicle may include, but are not limited to: total number of vehicle in the group, number of active vehicles in a group, current location of vehicle(s), current stop for vehicle(s), average number of stops, total drive time, average time of first departure, night load percentage, late yard departures, power take-off, inverter time, boom time, total number of stops, planned number of assignments, percent of time idle, total time idle, average miles, total miles, average miles per hour, amount of fuel used, miles per gallon, number of speed violations, number of off-hour incidents, number of alerts, and current odometer reading. The data may be received centrally from individual vehicles, and stored, e.g., in the database 130 for access and display.

The summary data may include a subset of the data that is visually distinguished from the rest, corresponding to one or more of the metrics exceeding a specified threshold for one or more KPIs. In addition, the summary data also may include totals corresponding to each KPI as measured across all groups.

The display 305 may include other functionality, e.g., the ability to search for a particular group, subgroup, or vehicle.

Next, in response to user input requesting a change 310 in the level of detail displayed in the user interface, the display is refined 315 corresponding to the requested change. For example, the request for a change 310 in the level of detail displayed may be a change from a first level of detail to a second level of detail for a particular group. In this example, the refined display 315 shows the plurality of key performance indicators corresponding to the second level of detail. If the first level of detail is summary data at the group level, then the second level of detail may be individual level data, subgroup level data, or aggregated data according to various refinements. The refined data, at any of the above levels, may be displayed in conjunction with the existing (e.g., summary data at group level) display, or may replace the existing data displayed according to various embodiments. When no request is made by the user to refine the level of data, the user interface continues to display 305 the existing listing of groups and associated summary data.

Similarly, in response to user input requesting a change 320 in the format of the data displayed in the user interface, the display is refined 315 corresponding to the requested change. For example, the request for a change 320 in the format of the data displayed may be a change from a first format to a second format. In this example, the refined display 315 shows the data in the second format. If the first format includes the group listing and summary data areas, then the second format may include a time trend display, or a mapping data display, etc., according to various refinements. Thus, the data may be refined to show changes over time, or geographical aspects of the data, respectively. The refined data may be displayed in conjunction with the existing data displayed, or may replace the existing display according to various embodiments. When no request is made by the user to refine the level of data, the user interface continues to display 305 the existing listing of groups and associated summary data.

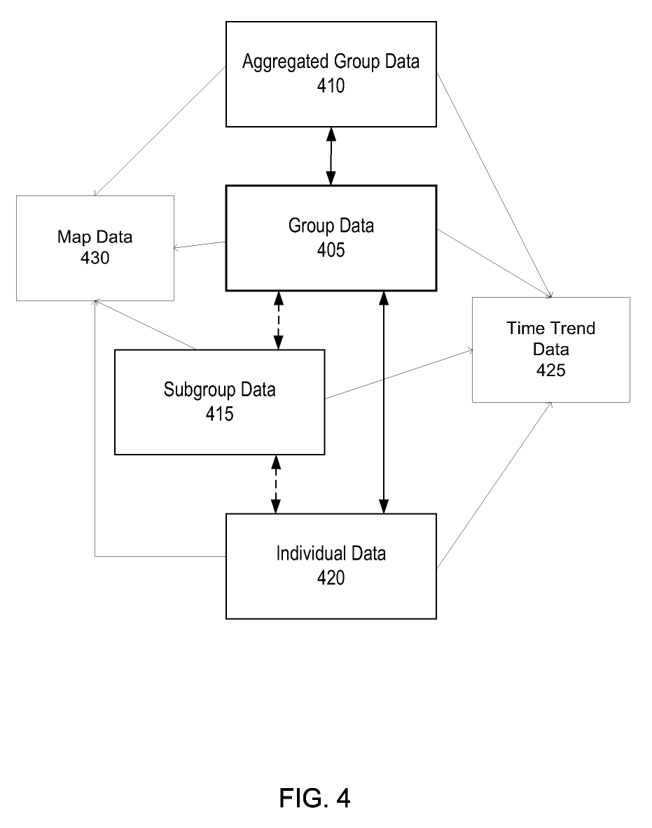

FIG. 4 is a flowchart illustrating various display options available in conjunction with the method of FIG. 3 according to one embodiment. Initially, group data 405 is displayed in a summary data display area. The summary data display area shows metrics for each KPI for a list of groups. In response to a request for a change in the level of detail displayed as discussed above, aggregated group data 410, subgroup data 415 (if applicable), or individual data 420 may be displayed. The aggregated group data 410 includes aggregation of the summary data as a single value for each of the groups across all KPIs selected. For example, this data may appear in a single column to the right of the list of groups. If the user selects a group from the list of groups for refinement, either subgroup data 415 or individual data 420 is displayed. The subgroup data 415, if it exists for a selected group, shows the group data 405 as distributed between various subgroups within the group. The individual data 420 instead is shown for groups without subgroups. The individual data 420 is data corresponding to individual vehicles within a group.

From any of the group data 405, aggregated group data 410, subgroup data 415, or individual data 420 displays, time trend data 425 or map data 430 may be shown in response to user input requesting a change in the format of the data displayed as described above.

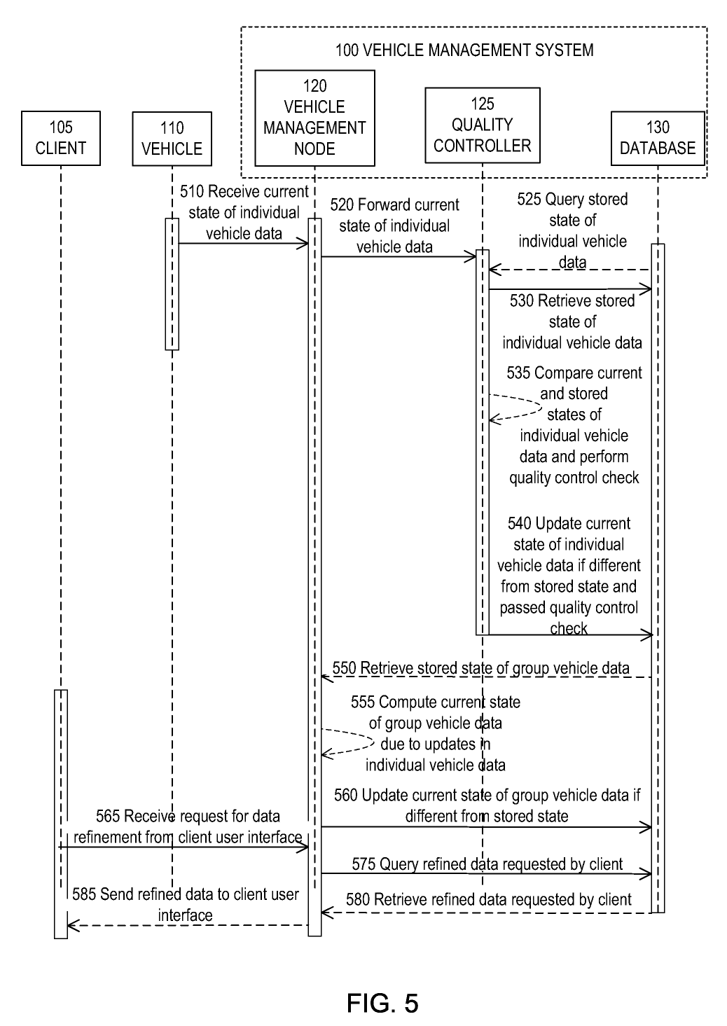

FIG. 5 is a sequence diagram illustrating backend functionality for the vehicle management system 100 according to one embodiment. The vehicle management system 100 receives 510 a current state of an individual vehicle from a vehicle 110, e.g., at periodic intervals or in response to a predetermined triggering event. The vehicle management node 120 forwards 520 the current data to a quality controller 125 and updates (525-540) the individual vehicle data, as follows. The quality controller 125 queries 525 the database 130 for the stored state of the individual vehicle data and retrieves 530 the stored state of the individual vehicle data. In one embodiment, the quality controller 125 retrieves the stored state of individual vehicle data by retrieving all the stored KPI metrics for the individual vehicle. The quality controller 125 then compares 535 the current and stored states of individual vehicle data to perform a quality control check to determine if the current value is plausible in view of the stored value. For example, if the current value for the KPI Total Miles is less than the stored value, then the current value is unacceptable and fails quality control. The quality controller 125 also compares 535 the current and stored states of individual vehicle data to determine if the values are different. The quality controller 125 then updates 540 the current state of the individual vehicle data in the database 130 if the value is different from the stored state. In one embodiment, updating the current state of the individual vehicle data includes re-assessing whether a metric fails to meet a specific threshold.

The vehicle management node 120 may then update (550-560) the group vehicle data (and/or subgroup or aggregate data), as follows. Once the quality controller 125 updates 540 the individual vehicle data, the vehicle management node 120 retrieves 550 the stored state of group vehicle data for all groups and subgroups of which the individual is a member. The vehicle management node 120 then computes 555 the current state of the group vehicle data. In one embodiment, computing the current state of group vehicle data includes, identifying the groups/subgroups of which the individual is a member, retrieving the KPI metrics for the individuals in these groups/subgroups, computing the updated KPI metrics for these groups/subgroups in light of the revised individual entry, computing the aggregate KPI metrics in the totals row and the aggregate column, re-assessing whether a metric fails to meet a specific threshold for groups/subgroups, and updating 560 the database 130 with these revised KPI metrics.

When the vehicle management node 120 receives 565 a request for refined data, the vehicle management node 120 processes (575-580) the request for refined data as follows. The vehicle management node 120 queries 575 the database 130 for the refined data requested by the client 105. In one embodiment, querying the database 130 for refined data includes querying the database 130 for: metrics that constitute the group data display area if the user requested data on a group, metrics that constitute the subgroup data display area if the user requested data on a subgroup, metrics that constitute the individual data display area if the user requested data on an individual, metrics that constitute the aggregated data display area if the user requested aggregated data, metrics that constitute the time trend data display area if the user requested time trend data, or metrics that constitute the mapping data display area if the user requested mapping data. The vehicle management node 120 retrieves 580 the refined data from the database 130 and sends 585 the refined data to the user interface on the client 105 for display.

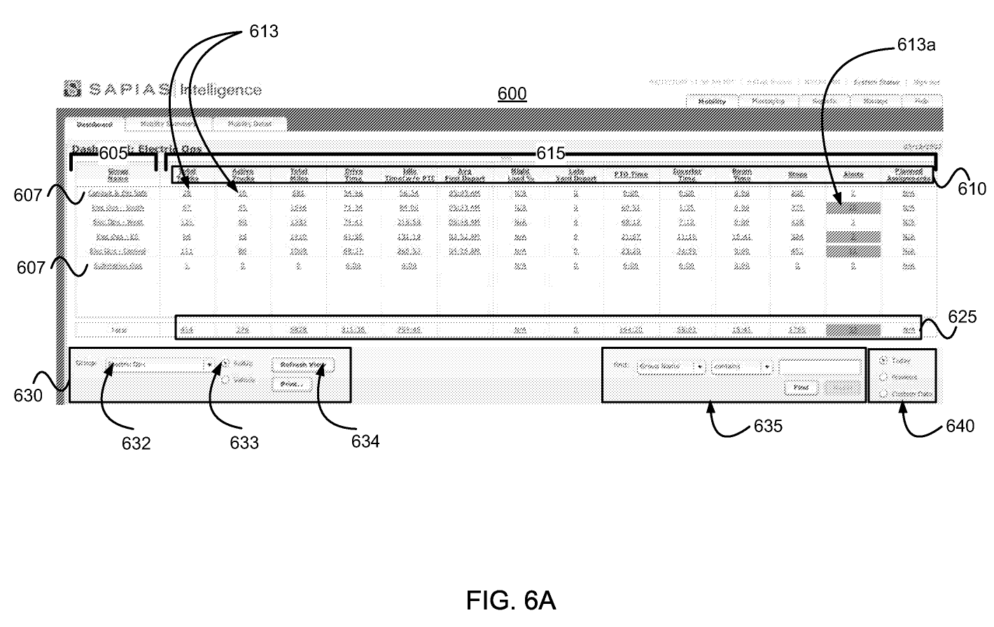

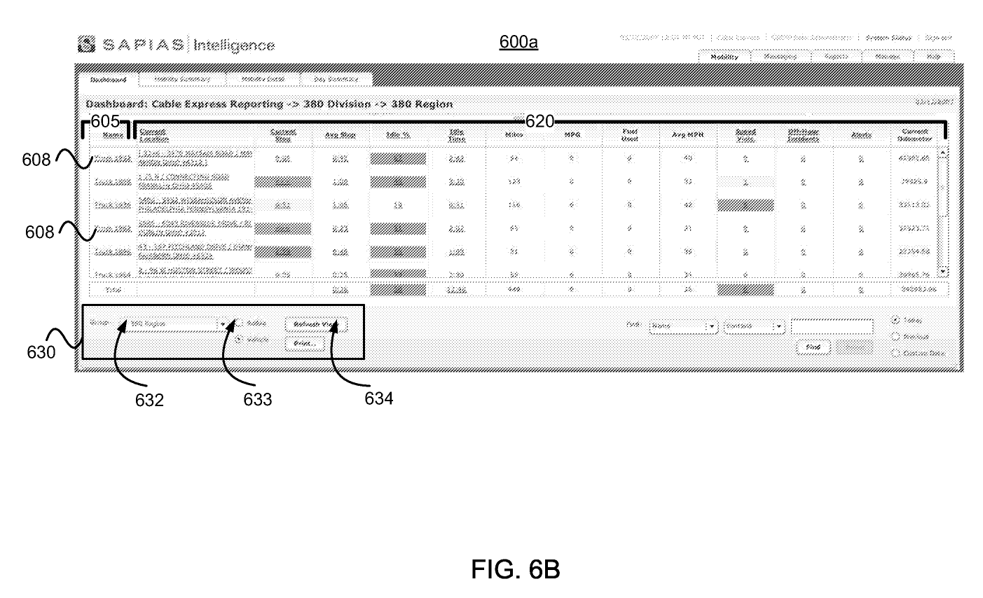

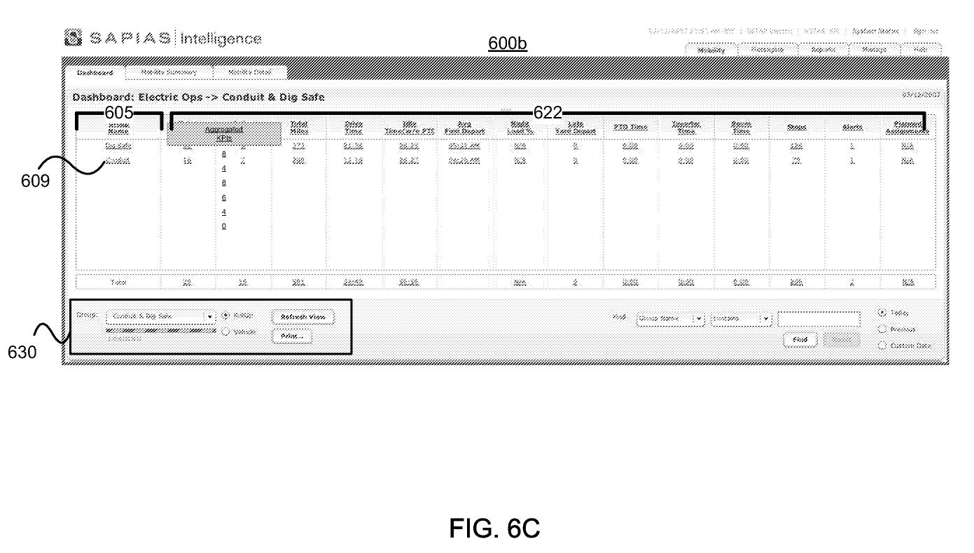

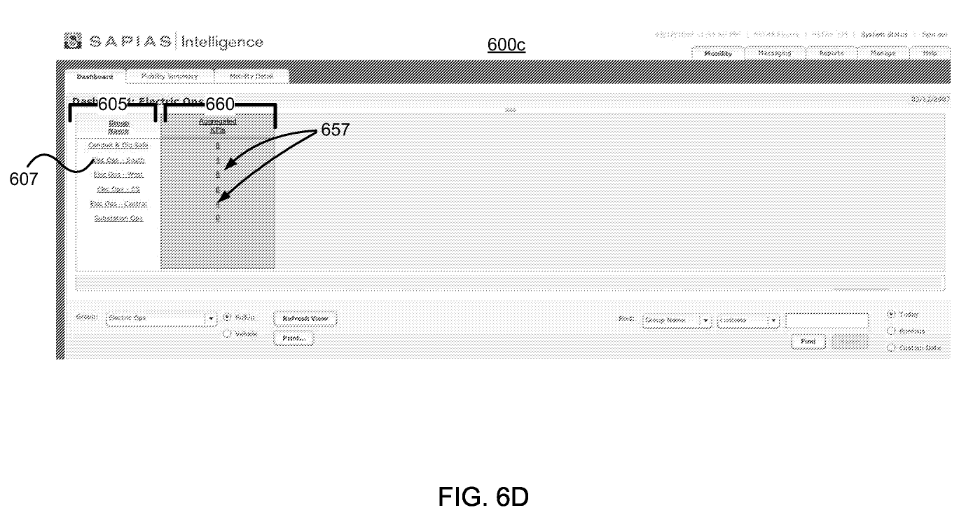

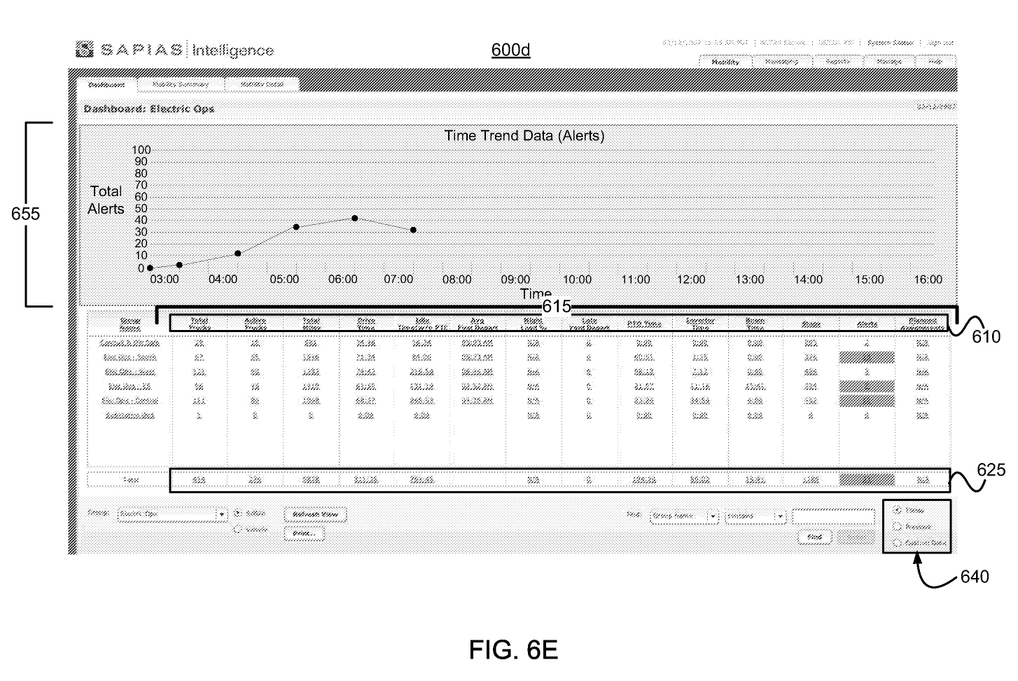

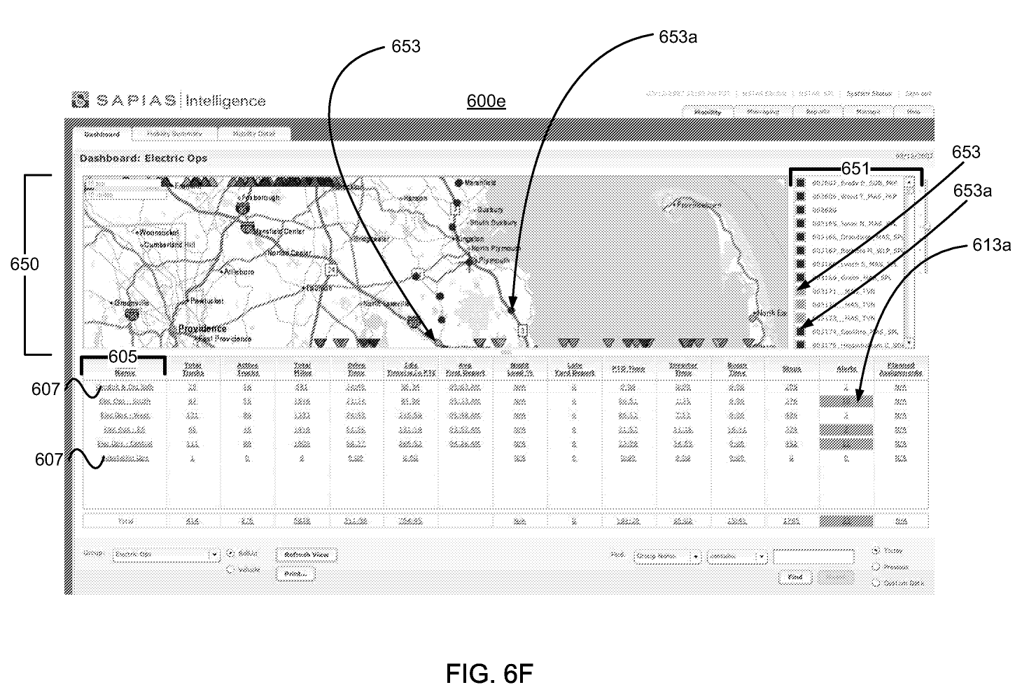

FIG. 6A shows a user interface 600 for a method of real-time management of vehicles corresponding to an enterprise according to one embodiment. The user interface 600 includes two major areas: a listing display area 605 and a summary data display area 615. The listing display area 605 lists groups 607 within the enterprise (in this example, “Electric Ops”). The summary data display area 615 includes fields filled with metrics 613 for each group 607 corresponding to various key performance indicators (KPIs) 610. As described herein, KPIs 610 represent scalar attributes used to measure performance for one or more vehicles. The summary data display area 615 includes a totals row 625 that shows the overall value for each KPI 610 across all the groups 607 displayed in the listing display area 605. If a metric 613 fails to meet a specified threshold value for a KPI 610, that metric 613 is visually distinguished in the summary data display area 615, e.g., 613a. Such metrics 613a may be visually distinguished in various ways, for example, by highlighting as shown in FIG. 6A, or by any other method that distinguishes the metrics 613a from the other metrics 613 in the summary data display area 615. In one embodiment, a color scheme is used that includes more than one threshold, and thus different colors are shown as different thresholds are crossed.

The user interface 600 also includes a detail level selection area 630. This area 630 allows the user to “drill-down” to a greater level of detail than that displayed, or to “roll up” to a greater level of abstraction than displayed. For example, since groups 607 for an entire enterprise are displayed, drilling down may include providing more detailed data for a selected group 607. In response to selection, e.g., of a group from the drop down menu 632, followed by clicking the refresh button 634, the user interface 600 will display the results of the request. The results may be shown within the summary data display area 615 itself, for example, by expanding a section underneath the corresponding group (not shown). Alternatively, the results may replace the summary data display area 615, as shown in FIG. 6B, described in greater detail below. The example in FIG. 6B shows individual vehicle data, however, for groups 607 that include subgroups, subgroup data may be displayed.

Similarly, rolling up may include providing group 607 data with less detail. In response to selection, e.g., of the roll up radio button 633, followed by clicking the refresh button 634, the user interface 600 will display the results of the request. The results may be shown within the summary data display area 615 itself, for example, by adding a column with aggregated data (not shown). Alternatively, the results may replace the summary data display area 615, as shown in FIG. 6C, described in greater detail below.

The user interface 600 also may include a group search area 635 enabling the user to find a group (e.g., by choosing “Group Name” from a drop-down list), choosing a wildcard search feature (e.g., “contains” to search for a substring), entering a substring in the empty textbox, and finding the desired group by clicking on the “Find” button.

The user interface 600 also may include a time trend display selection area 640 for the user to choose a time period for the data displayed in the summary data display area 615 (e.g., by clicking on one of the radio buttons). In one embodiment, the time trend display selection area 640 further enables display of a time trend graph 655 for the chosen timeframe for a selected KPI, or for each KPI, for the totals displayed in the totals row 625. FIG. 6E, described in greater detail below, shows such a time trend graph 655.

FIG. 6B shows a user interface 600a for a method of real-time management of vehicles corresponding to a group (or subgroup) according to one embodiment. The user interface 600a shown is similar to the user interface 600 shown in FIG. 6A, except that the listing display area 605 displays individual vehicles 608, and the summary data display area 615 of FIG. 6A has been replaced by a individual data display area 620. The individual data display area 620 is similar to the summary data display area 615 in that it includes fields filled with metrics 613 corresponding to various KPIs 610, however, in the individual data display area 620 the KPIs 610 correspond to individual vehicles. The replacement of the summary data display area 615 with the individual data display area 620 may be in response to selection of a subgroup, or a group that has no subgroups, from the drop down menu 632 described in conjunctions with FIG. 6A. The user may opt to roll up a level from this user interface 600a as well, e.g., by selection of the roll up radio button 633, followed by clicking the refresh button 634, in the detail level selection area 630 as discussed above.

FIG. 6C shows a user interface 600b for a method of real-time management of vehicles corresponding a subgroup according to one embodiment. The user interface 600b shown is similar to the user interface 600 shown in FIG. 6A, except that the listing display area 605 displays subgroups 609, and the summary data display area 615 of FIG. 6A has been replaced by a subgroup data display area 622. The example shows the subgroups 609 “Dig Safe” and “Conduit” that exist within the group 607 “Conduit & Dig Safe” and the corresponding metrics within the subgroup data display area 622 for each of the KPIs 610. The detail level selection area 630 applies to this user interface 600b as well.

FIG. 6D shows a user interface 600c for a method of real-time management of vehicles corresponding to a group metric aggregation according to one embodiment. The user interface 600c shown is similar to the user interface 600 shown in FIG. 6A, except that the summary data display area 615 of FIG. 6A has been replaced by an aggregated data display area 660, with an aggregated metric 657 listed for each group 607. In this example, the aggregated metric 657 is a single compound metric for each group in the listing display area 605 that represents an aggregation of the metrics for each individual KPI 610 across each group 607. In the embodiment shown, the aggregated metric 657 is normalized such that it ranges from 0 to 10, wherein 0 is lowest and 10 is highest. From the example, it is thus evident that the groups “Conduit & Dig Safe” and “Elec Ops—West” have the best overall aggregated metric 657, and the group “Substation Ops” has the worst aggregated metric 657 across the same set of KPIs. In another embodiment, the compound metric is computed across a user-defined subset of KPIs. The user may opt to drill down one or more levels from this user interface 600c as well, using the detail level selection area 630 as discussed above.

The various levels of detail that the user interface 600 may display allow a user to quickly get an overview of how all groups in an enterprise are performing, relatively speaking (FIG. 6C), or see various levels of detail for the group as a whole (FIG. 6A) or for individual vehicles in a group (FIG. 6B).

FIG. 6E is a user interface 600d for a method of real-time management of vehicles including a time trend graph 655 according to one embodiment. As described above, the time trend graph 655 displays in response to selection of a time period within the time trend display selection area 640, in this example, from the user interface 600 of FIG. 6A. In the example shown, the time trend graph 655 displays values from the totals row 625 for the “Alerts” KPI between 3:00 AM and 7:30 AM during the course of the current day, as selected in box 640. In another embodiment, a time trend graph is displayed for each of the KPIs 610. Note that the depicted example corresponds to group values for the KPIs, corresponding with the summary data display area 615. However, by selecting a time period within the time trend display selection area 640 while viewing a user interface showing a different level of detail, e.g., UIs 600a-c, the time trend graph 655 displayed corresponds to the data shown for the individual, subgroup, or aggregated data, respectively. This allows the user to see various trends in the data overtime.

FIG. 6F shows a user interface 600e for a method of real-time management of vehicles including a map display area 650 according to one embodiment. In the depicted example, the map display area 650 shows the locations of individual vehicles within each of the plurality of groups 607 in the listing display area 605. In one embodiment, the vehicle location markers 653 on the map 650 for vehicles that fail to meet user-defined threshold values for KPIs 610, which were visually distinguished 613a, as described in conjunction with FIG. 6A, also are visually distinguished 653 on the map 650 and or sidebar 651. The color scheme, or other manner of distinguishing the metrics 613a on the summary data display area 615 may also be used for the distinguished location markers 653a on the map 650. This allows the user to see the data displayed in a more visual manner. In one embodiment, vehicles off the displayed map area are so indicated, e.g., as triangles in this example. In this example, the triangles also may be visually distinguished.

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

We claim:

1. A computer readable memory storing a computer program executable by a processor, the computer program producing a user interface of a real-time vehicle management application, the user interface comprising:
a listing display area comprising a plurality of groups, each group corresponding to a plurality of vehicles;
a summary data display area comprising, for each of the plurality of groups, fields comprising metrics corresponding to a plurality of key performance indicators for each of the plurality of vehicles; and,
wherein a field comprising a metric failing to meet a specified threshold value for one of the plurality of key performance indicators is visually distinguished within the summary data display area.

2. The computer readable memory product of claim 1, wherein the user interface is adapted to, in response to user input requesting a refinement of the user interface corresponding to a change from a first level of detail to a second level of detail, display a refined data display area corresponding to the refinement, wherein the refined data display area comprises the fields comprising the metrics corresponding to the plurality of key performance indicators for the second level of detail.

3. The computer readable memory product of claim 2, wherein first level of detail is the group level, and the second level of detail is the subgroup level.

4. The computer readable memory product of claim 2, wherein first level of detail is the group level, and the second level of detail is the individual level.

5. The computer readable memory product of claim 2, wherein first level of detail is the group level, and the second level of detail is the aggregate level, wherein the refinement includes an aggregated data display area comprising an aggregation score for each of the plurality of groups, the aggregation score comprising a single value corresponding to an aggregation of the metrics for the plurality of key performance indicators for each of the plurality of groups.

6. The computer readable memory product of claim 2, wherein the refinement replaces the summary data display area.

7. The computer readable memory product of claim 1, wherein the user interface is adapted to, in response to user input requesting a refinement of the user interface corresponding to a change from a first display format to a second display format, display a refined data display area corresponding to the refinement, wherein the refined data display area comprises the second display format.

8. The computer readable memory product of claim 7, wherein the refinement replaces the summary data display area.

9. The computer readable memory product of claim 7, wherein the refinement includes a time trend data display area comprising a graph showing the metrics for each of the plurality of key performance indicators for each of the plurality of groups over time.

10. The computer readable memory product of claim 7, wherein the refinement further comprises displaying a map display area comprising, for each of the plurality of vehicles associated with each of the plurality of groups in the summary data display area, a current location indicator corresponding to the each of the plurality of vehicles.

11. A method for real-time management of vehicles, comprising:
displaying a group data display area comprising a plurality of groups, each group corresponding to a plurality of vehicles;
displaying a summary data display area comprising, for each of the plurality of groups, fields comprising metrics corresponding to a plurality of key performance indicators associated with a plurality of vehicles; and
visually distinguishing the field comprising the metric in response to a metric exceeding a specified threshold value for one of the plurality of key performance indicators.

12. The method of claim 11, further comprising displaying a refined data display area in response to user input requesting a refinement of the user interface corresponding to a change from a first level of detail to a second level of detail, wherein the refined data display area comprises the fields comprising the metrics corresponding to the plurality of key performance indicators for the second level of detail.

13. The method of claim 12, wherein first level of detail is the group level, and the second level of detail is the subgroup level.

14. The method of claim 12, wherein first level of detail is the group level, and the second level of detail is the individual level.

15. The method of claim 12, wherein first level of detail is the group level, and the second level of detail is the aggregate level

16. The method of claim 12, wherein the refinement replaces the summary data display area.

17. The method of claim 11, further comprising displaying a refined data display area in response to user input requesting a refinement of the user interface corresponding to a change from a first display format to a second display format, wherein the refined data display area comprises the second display format.

18. The method of claim 17, wherein the refinement replaces the summary data display area.

19. A system for real-time management of vehicles, comprising:
a display module for displaying a user interface comprising a summary display area;
a grouping module for grouping data corresponding to a plurality of groups, each group corresponding to a plurality of vehicles;
a summarizing module for summarizing the grouped data and for displaying the grouped data in the summary display area, for each of the plurality of groups, the summary display area comprising fields comprising metrics corresponding to a plurality of key performance indicators associated with the plurality of vehicles; and
a visual distinguishment module for visually distinguishing, within the summary data display area, a field comprising a metric failing to meet a specified threshold value for one of the plurality of key performance indicators associated with a plurality of vehicles.

20. The system of claim 19, wherein the display module is further configured to refine the user interface in response to user input.
